(19) United States
(12) Patent Application Publication
(10) Pub. No.: US 2017/0189849 A1
(43) Pub. Date: Jul. 6, 2017

(54) Device and Method for Treating a Gas Flow

(71) Applicant: Matthias ENZENHOFER, Heilbronn (DE)

(72) Inventor: Matthias Enzenhofer, Heilbronn (DE)

(21) Appl. No.: 15/313,735

(22) PCT Filed: May 21, 2015
(86) PCT No.: PCT/EP2015/061301

§ 371 Date: Nov. 23, 2016

(30) Foreign Application Priority Data
May 23, 2014 (DE) 10 2014 209 924.2

(51) Int. Cl. B01D 53/14; F02C 3/20

(52) U.S. Cl. CPC B01D 53/1487; B01D 53/1425; F02C 3/20; F05D 2220/32

(57) ABSTRACT

A device and a method treats a gas flow. Combustible components are separated from a first gas flow by means of an absorption process using a liquid medium in an absorption device; the components dissolved in the liquid medium are deposited into a second gas flow by means of a desorption process in a desorption device; and the concentration of combustible components in the second gas flow is set to a specified value. The second gas flow with the combustible components is additionally supplied to a gas turbine as fuel in order to generate electric energy and heat. A virtually energy-neutral exhaust air purification process is possible using the proposed device and method.

### BACKGROUND

The invention relates to a device and a method for treating a gas flow.

The term combined heat and power (CHP) refers to the simultaneous conversion of employed primary energy into electricity and heat. CHP permits high-efficiency energy conversion and is therefore suitable in particular for local energy supply solutions for industry or agriculture. In modern CHP plants, use is often made of (micro-)gas turbines which can be operated with a great number of possible fuels and permit particularly environmentally friendly generation of heat and electricity.

A gas turbine has an air inlet, a compressor part, a combustion chamber in which the compressed air is mixed with fuel that is supplied to the combustion chamber via a fuel inlet, and the fuel-air mixture is burnt. The resulting hot gas is fed through the actual turbine which is mounted on the same shaft as the compressor and thus drives the latter. For electricity generation, a generator can be driven by the rotating shaft.

Many fields of industry, such as the printing industry or paint shops, produce large quantities of exhaust air that is loaded with volatile organic compounds (VOCs). The VOCs must be removed from this exhaust air in order to comply with national and international emissions limits, and to be able to release the exhaust air into the environment without this posing a risk.

### SUMMARY

VOCs are a suitable fuel for micro-gas turbines. A device and a method are provided which permit both satisfactory cleaning of exhaust air loaded with VOCs, and also the generation of electricity and heat using the separated VOCs.

In a first aspect, a device for treating a gas stream has at least an absorption device which is suitable for removing flammable constituents from a first gas stream by absorption using a liquid medium; a desorption device which is suitable for separating flammable constituents dissolved in the liquid medium into a second gas stream, preferably an air stream, and a micro-gas turbine. In that context, the concentration of flammable constituents in the second gas stream can be set to a predetermined value and the micro-gas turbine is supplied with the second gas stream, containing the flammable constituents, as fuel. In that context, the micro-gas turbine is supplied only with the second gas stream as fuel. No additional fuel, for example in the form of natural gas, is required. Preferably, the second gas stream, which consists of air with flammable constituents contained therein, is supplied to the air inlet of the gas turbine without additional fuel being supplied to the combustion chamber via the fuel inlet.

The device makes it possible for flammable constituents, which can in particular be VOCs, to be reliably removed from a gas stream, which can in particular be an exhaust air stream from a production plant. The flammable constituents, which are separated by absorption into a liquid medium, are separated in the desorption device into a second gas stream and are concentrated to a predetermined value in order to generate a gas stream that is suitable for operating the micro-gas turbine. Operating the micro-gas turbine using the flammable constituents from the exhaust air stream permits exhaust air cleaning that is almost energy-neutral overall.

In a further embodiment, the micro-gas turbine is started using a predetermined fuel that is different from the second gas stream containing the flammable constituents. Using another fuel, which can for example be natural gas, for starting the micro-gas turbine ensures reliable start-up of the micro-gas turbine such that, in subsequent operation, the micro-gas turbine can be switched to burning the flammable constituents contained in the second gas stream. In that context, for starting the micro-gas turbine the other fuel can be supplied to the combustion chamber via the fuel inlet.

The absorption device of the device then preferably comprises the following: a carrier arrangement having an inlet and an outlet for the liquid medium, the carrier arrangement being configured such that, between the inlet and the outlet, the liquid medium is guided past a number of carriers and forms a flowing liquid film on the surface of the carriers; and a gas stream guide which is configured such that the first gas stream comes into contact with the flowing liquid film on the surface of the number of carriers.

The flowing liquid film is preferably a falling film which flows essentially vertically from top to bottom. The gas stream is preferably guided in transverse flow with respect to the liquid film. The carriers used are preferably porous hoses, for example heat-treated knitted hoses made of plastic.

The above-described absorption device permits thorough removal of flammable constituents, in particular VOCs, from a gas stream. The take-up of the flammable constituents into the liquid medium permits simple transportation onward to the desorption device of the device, which can be arranged spatially separated from the absorption device.

The desorption device used is preferably a desorption column into which the liquid medium loaded with the flammable constituents is fed, possibly after heating, via the column head, the liquid medium then moving via column packing to the column sump, whence it is returned to the absorption stage. In that context, in the column the liquid medium is brought into contact with a gas, preferably air, in counter-flow, such that the flammable constituents pass from the liquid medium into the gas stream of the desorption device.

In a second aspect, a method for treating a gas stream has the steps of: removing flammable constituents from a first gas stream by absorption using a liquid medium; separating the flammable constituents dissolved in the liquid medium into a second gas stream by desorption; setting the concentration of flammable constituents in the second gas stream to a predetermined value; and supplying the second gas stream, containing the flammable constituents, as fuel to a micro-gas turbine.

The method makes it possible, in a manner that is simple in terms of process, to produce, from a first gas stream that can for example be an exhaust gas stream from an industrial plant, a second gas stream that is suitable as a fuel for the micro-gas turbine. Using the flammable constituents contained in the exhaust air stream as fuel for the micro-gas turbine permits exhaust air cleaning that is almost energy-neutral overall.

In a further embodiment of the method, the micro-gas turbine can be started using a predetermined fuel that is different from the second gas stream containing the flammable constituents. Using another fuel, which can for example be natural gas, for starting the micro-gas turbine can ensure reliable start-up of the micro-gas turbine such that, in the subsequent process, the micro-gas turbine can be switched to burning flammable constituents contained in the exhaust gas stream.

### BRIEF DESCRIPTION OF THE DRAWINGS

The invention will be explained in greater detail below, with reference to the appended drawings, in which identical reference signs denote identical or functionally equivalent elements, and in which:

FIG. 1 is a schematic illustration of an absorption device;

FIG. 2 is a schematic illustration of a desorption device;

FIG. 3 is a schematic illustration of a micro-gas turbine; and

FIG. 4 is a schematic illustration of the device for treating gas streams.

### DETAILED DESCRIPTION

FIG. 4 shows, schematically, the device for treating a gas stream, having an absorption device 10, a desorption device 20 and a micro-gas turbine 30.

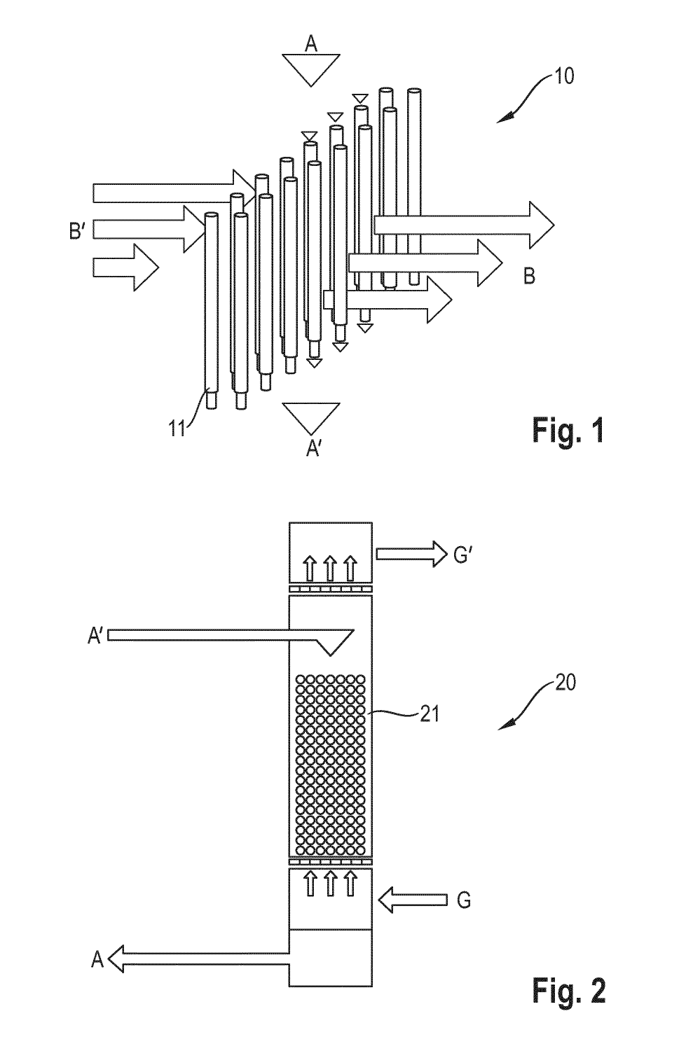

As shown in greater detail in FIG. 1, a gas stream B′, which can for example be an exhaust gas stream and is loaded with flammable constituents, in particular VOCs, introduced into the absorption device 10. The absorption device 10 comprises a carrier arrangement having an inlet and an outlet for a liquid medium A, the carrier arrangement being configured such that, between the inlet and the outlet, the liquid medium is guided past a number of carriers 11 and forms a flowing liquid film on the surface of the carriers 11. The gas stream guide of the absorption device 10 is configured such that the first gas stream B′ comes into contact with the flowing liquid film on the surface of the number of carriers 11, such that the flammable constituents in the first gas stream B′ can be absorbed by the liquid medium A and, after passing through the number of carriers 11, a cleaned first gas stream B can leave the absorption device 10. After contact with the loaded first gas stream B′, the liquid medium A′, which is now charged with flammable constituents, is guided out of the absorption device 10 via an outlet and is subsequently fed to the desorption device 20 shown in FIG. 2.

The desorption device 20 has a column 21 supplied with the liquid medium A′, which is heated and charged with flammable constituents. The liquid medium A′ is added to the head of the column 21 and, in counter-flow to the liquid medium A′, air is supplied as a second gas stream G so as to be enriched with the flammable constituents from the liquid medium A′. Thus, the liquid medium A′ can be regenerated, collected in the sump of the column 21 and subsequently returned, clean, to the absorption device 10. Also, the second gas stream G can be enriched with the flammable constituents, such that it is possible to create a gas stream G′ which is suitable for combustion in a micro-gas turbine. In particular, the desorption device 20 is configured such that the concentration of flammable constituents in the second gas stream G′ which is suitable for combustion can be set to a predetermined value. This can be achieved for example by regulating the volumetric flow of the gas stream G.

A suitable flammable constituent in the second gas stream is for example butanol, combustion in a micro-gas turbine being possible for a concentration of at least 1.8 g of butanol per cubic meter of air. Especially suitable for combustion is a concentration in the range of 3.3-3.8 g of butanol per cubic meter of air.

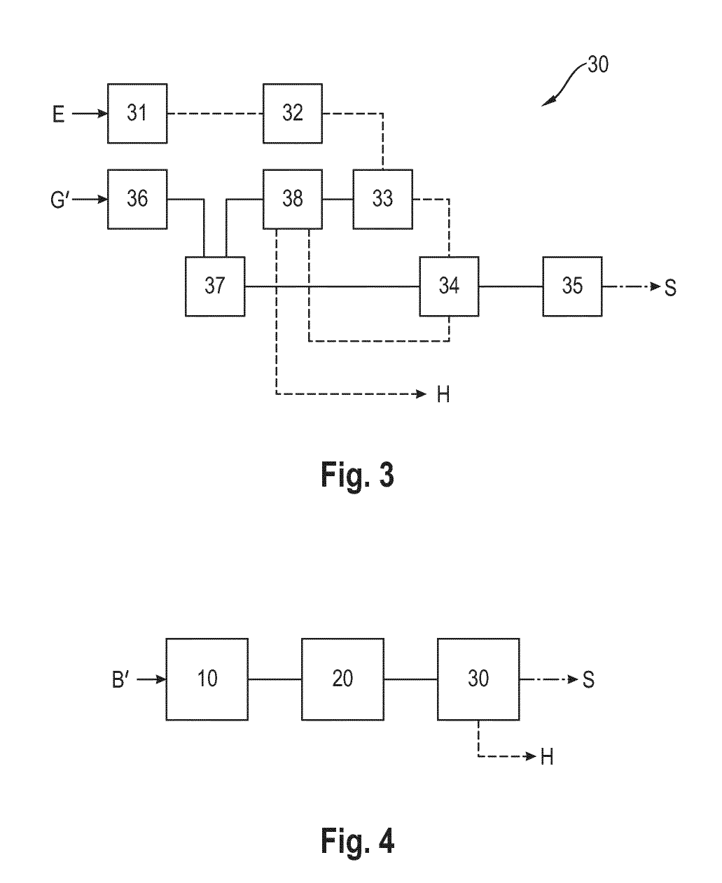

Combustion of the second gas stream G′ takes place in a micro-gas turbine 30 which is illustrated schematically and by way of example in FIG. 3. First, a compressor 37 draws the gas stream G′ through an air filter 36 and usually compresses it to pressures of greater than 5 bar. On start-up, it is possible for natural gas E to be drawn through a fuel filter 31, and compressed, by a fuel compressor 32. Then, an exhaust gas heat exchanger 38 is provided in the micro-gas turbine 30 in order to use the heat of the turbine 34 for heating the combustion air (gas stream G′) that is compressed in the air compressor 37.

After natural gas E has been supplied, possibly for starting the turbine, the supply of natural gas is switched off and combustion in the combustion chamber is sustained only by the gas stream G′, which contains both the combustion air and the flammable constituent as fuel. Conventional flashback prevention means may be provided between the combustion chamber 33 and the compressor 37 in order to restrict combustion to the combustion chamber 33. For starting the turbine, the combustion chamber 33 contains an ignition device. The hot combustion gases are then expanded in the turbine 34, in order to thus drive the air compressor 37 and a generator 35 for electricity generation. A suitable generator 35 is for example a permanent magnet generator, which can be operated without interconnection of a mechanical gearing.

The generator generates electrical energy S which can subsequently be used for example for operating the absorption device 10, the desorption device 20, or for feeding into the electrical grid. Furthermore, the exhaust gas heat exchanger 38 provides hot gas H which can be further used in processes such as heating the liquid medium A′ in the desorption device 20.

The proposed device makes it possible to clean an exhaust air stream and simultaneously permits the generation of electrical energy and heat, in order to thus permit almost energy-neutral exhaust air cleaning.

1. A device for treating a gas stream, having at least
an absorption device which is suitable for removing flammable constituents from a first gas stream by absorption using a liquid medium;
a desorption device which is suitable for separating flammable constituents dissolved in the liquid medium into a second gas stream; and
a gas turbine,
wherein the flammable constituents in the second gas stream have a concentration which can be set to a predetermined value; and
wherein the gas turbine is supplied with the second gas stream, containing the flammable constituents, as fuel.

2. The device as claimed in claim 1, wherein the gas turbine is supplied with no other fuel in addition to the second gas stream containing the flammable constituents.

3. The device as claimed in claim 1, wherein the absorption device comprises the following:
a carrier arrangement having an inlet and an outlet for the liquid medium, the carrier arrangement being configured such that, between the inlet and the outlet, the liquid medium is guided past a number of carriers having a surface and forms a flowing liquid film on the surface of the carriers; and
a gas stream guide which is configured such that the first gas stream comes into contact with the flowing liquid film on the surface of the number of carriers.

4. A method for treating a gas stream, having the steps of:
removing flammable constituents from a first gas stream by absorption using a liquid medium;
separating the flammable constituents dissolved in the liquid medium into a second gas stream by desorption wherein the flammable constituents in the second gas stream have a concentration;
setting the concentration of flammable constituents in the second gas stream to a predetermined value; and
supplying the second gas stream, containing the flammable constituents, as fuel to a gas turbine.

5. The method as claimed in claim 4, wherein the gas turbine is supplied with no other fuel in addition to the second gas stream containing the flammable constituents.

6. The device as claimed in claim 2, wherein the absorption device comprises the following:
a carrier arrangement having an inlet and an outlet for the liquid medium, the carrier arrangement being configured such that, between the inlet and the outlet, the liquid medium is guided past a number of carriers having a surface and forms a flowing liquid film on the surface of the carriers; and
a gas stream guide which is configured such that the first gas stream comes into contact with the flowing liquid film on the surface of the number of carriers.
